(19) United States
(12) Patent Application Publication
(10) Pub. No.: US 2010/0011632 A1
(43) Pub. Date: Jan. 21, 2010

(54) GREETING CARD HAVING CONNECTIVITY CAPABILITIES

(75) Inventors: Christopher Jason Shields, Kansas City, MO (US); Omar A. Martinez, Kansas City, MO (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: HALLMARK CARDS, INCORPORATED, Kansas City, MO (US)

(21) Appl. No.: 12/175,267

(22) Filed: Jul. 17, 2008

(51) Int. Cl. G09F 1/00; H01R 13/648

(52) U.S. Cl. 40/124.01; 439/607.01

(57) ABSTRACT

The present invention relates to a greeting card with the capability of connecting to and interacting with a device. More particularly, this invention relates to a card having a connector that permits a memory device coupled with the card to interact with a device, such as a multimedia player or computing device. The memory device may include a file, such as a video or image, that has been stored by the card purchaser and that can then be executed on the device for the enjoyment of the card recipient. The memory device may store a file for the greeting card recipient to access or view on a device, such as a multimedia player, when the card is connected to the device. Additionally, the memory device may include executable software that causes the device to perform an action, such as opening up a webpage, once the card is connected to the device. In such an embodiment, the card may be a gift card, such as a standard gift card issued by retailers. When the card is connected to a device, such as a computing device, the card recipient will be able make purchases using a monetary value that has been placed on the gift card by the card purchaser.

### CROSS-REFERENCE TO RELATED APPLICATIONS

Not applicable.

### STATEMENT REGARDING FEDERALLY SPONSORED RESEARCH OR DEVELOPMENT

Not applicable.

### BRIEF SUMMARY OF THE INVENTION

The present invention relates to a greeting card with the capability of connecting to and interacting with a device. More particularly, this invention relates to a card having a connector that permits a memory device coupled to the card to interact with a device, such as a multimedia player or computing device. The memory device may include a file, such as a video or image, that can then be executed on the device for the enjoyment of the card recipient. Additionally, the memory device may include executable software that causes the device to perform an action, such as opening up a webpage, once the card is connected to the device. The purchaser of the card may customize the file stored on the memory device.

In one embodiment, the card is a greeting card, where the connector and memory device are coupled with the greeting card. In such an embodiment, the memory device may store a file for the greeting card recipient to access or view on a device, such as a multimedia player. To store a file on the memory device, the purchaser of the gift card may receive instructions when purchasing the card. By way of example, without limitation, the purchaser may be instructed to visit a webpage associated with the card, and to upload files the purchaser wishes to store on the memory device. The purchaser may alternatively be able to add files to the memory device while at the store purchasing the card.

In another embodiment, the card may be a gift card, such as a standard gift card issued by retailers. Instead of storing a file in the memory device of the gift card, the purchaser may be able to add a monetary value to the gift card. Then, when the card is connected to a device, such as a computing device, the card recipient will be able make purchases using the value on the gift card. In some embodiments, software on the memory device may cause the device to automatically access a webpage or other application that directs the card recipient to the retailer (e.g., the retailer's webpage).

Further objects, features and advantages of the present invention over the prior art will become apparent from the detailed description of the drawings which follows, when considered with the attached figures.

### BRIEF DESCRIPTION OF THE SEVERAL VIEWS OF THE DRAWING

The features of the invention noted above are explained in more detail with reference to the embodiments illustrated in the attached drawing figures, in which like reference numerals denote like elements, in which FIGS. 1-7 illustrate several possible embodiments of the present invention, and in which:

FIG. 1 is a perspective view of an interior of an opened greeting card constructed in accordance with an embodiment of the present invention;

FIG. 2 is a side elevation of the interior of an opened greeting card, in accordance with another embodiment of the present invention;

FIG. 3 is a perspective view of a component of the greeting card of FIG. 2;

FIG. 4 is a perspective view of an opened greeting card constructed in accordance with another embodiment of the present invention;

FIG. 5 is a side elevation view of a gift card removed from the greeting card of FIG. 4;

FIG. 6 is a side elevation view of the gift card of FIG. 5 having a portion of the rest cut away to reveal a memory device; and

FIG. 7 is a perspective view of a card constructed in accordance with an embodiment of the present invention coupled to a multimedia device.

### DETAILED DESCRIPTION OF THE INVENTION

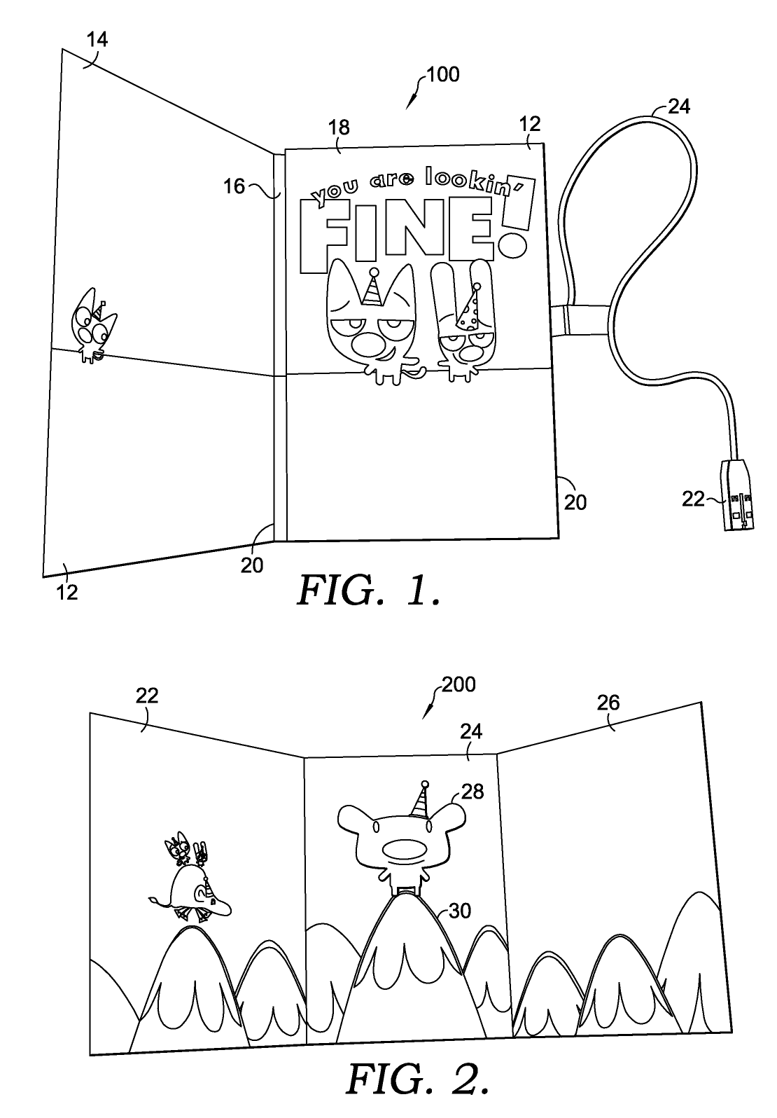

Referring now to the drawings in more detail and initially to FIG. 1, numeral 100 generally designates a greeting card constructed in accordance with an embodiment of the present invention. The greeting card 100 includes a card body 12. In the illustrated embodiment, the card body 12 includes a front panel 14, a back panel 16, and an interior panel 18. As readily understood by one of ordinary skill in the art, the card body 12 may consist of a single piece of card stock that has been folded along fold lines 20 to provide panels 14, 16 and 18, as depicted in the illustrated embodiment. It would also be readily understood that the panels 14, 16, 18 may be individual panels that are joined to one another by any number of methods known in the art and that the card body 12 could have any number of panels.

A connector 22 is also provided and is preferably coupled with the card body 12. In the illustrated embodiment, the connector 22 is attached to the card body 12 via a connecting cord 24. The connector 22, however, may be coupled directly to the card body 12. As one skilled in the art will appreciate, such an embodiment would also be within the scope of the present invention.

Turning now to FIG. 4, a greeting card 400 together with a removable gift card is provided as another embodiment of the present invention. Here, the greeting card 400 includes a card body 42. In the illustrated embodiment, an interior panel 46 has been folded back such that it overlies a back panel 44. The interior panel 46 and the back panel 44 have been secured together along an edge 78 of the card body 42. An upper edge 80 of the interior panel 46 has been left unsecured to the back panel 44. As such, the interior panel 46 and the back panel 44 define a pocket or cavity 82 into which a card, such as gift card 50, may be positioned.

One skilled in the art will appreciate, however, that gift card 50 may be coupled with the greeting card 400 in any manner known in the art. For example, in an alternative embodiment, the back panel 44 may provide an indentation in the card body 42 into which the gift card 50 could be placed. Similarly, the back panel 44 may be provided with slits that receive corners of the gift card 50.

The gift card 50 may be any type of card that is issued by a retailer or a bank to be used as an alternative to a non-monetary gift. As can be seen in FIGS. 4-6, the gift card 50 includes a connector 48, which serves to connect the gift card 50 to a multimedia player, a computing device, and/or the like, and which will be more fully described below. Additionally, the gift card 50 may include a design 56 on the face of the card, where the design may serve a purely aesthetic purpose or may, in addition to or alternatively, represent the retailer to which the gift card 50 may be redeemed. Further, the denomination of money that is included on the gift card 50 may be shown on the face of the card, as is indicated by marker 58.

In embodiments of the invention, where a card, such as gift card 50, includes a monetary value, one skilled in the art will appreciate that various methods may be used in adding the monetary value to the card. For example, a person that purchases the card may be provided with instructions, such as visiting the retailer's webpage or another webpage associated with the card, in order to add value to the card. In a further example, the purchaser of the card may add value to the card at the point of sale, such as via a kiosk at the store.

The connector 48 preferably includes any type of universal connector that is appropriately sized to attach to a card. Exemplary connectors include a universal serial bus (USB) connector, [LIST OTHER CONNECTORS]. The connector 48 is coupled with a memory device 62, as shown in FIG. 6. In the illustrated embodiment, such a memory device 62 is concealed inside of the gift card 50.

Further, the connector 48 is capable of connecting to a multimedia player, a computing device, and the like. Exemplary multimedia players that may be used in conjunction with this invention include a cell phone, a handheld gaming device, a Blackberry type device, a PDA, a music player (e.g., an ipod), etc.; however, one skilled in the art will appreciate that any device that is capable of connecting to the card using a connector and interacting with the memory device coupled to the card may be used.

As will be appreciated in the art, the memory device 62 may be any type of device capable of storing data that is also of an appropriate size to be coupled with a card, such as a gift card or greeting card. More particularly, exemplary media files that may be stored on the memory device 62 include an audio file, a video file, an image file, or any combination thereof.

Further, the memory device 62 may include executable software. In embodiments where the memory device 62 has executable software stored thereon, such software may cause a computing device to automatically execute certain actions, once the gift card 50 is connected via connector 48 to the computing device. For example, when the gift card 50 is affiliated with a specific retailer and contains a monetary value, the computing device may be instructed to open a browser and be directed to the webpage of the retailer, based on instructions from the software on the memory device 62.

In other embodiments, the purchaser of the card or gift card may receive instructions when purchasing the card to visit a designated webpage, where the purchaser can upload files (e.g., image, video, audio files) or create any other type of message or greeting for the card recipient. Then, when the recipient connects the card to a computing device, the computing device is directed to a related webpage that the recipient can then access to view the greeting, files, etc.

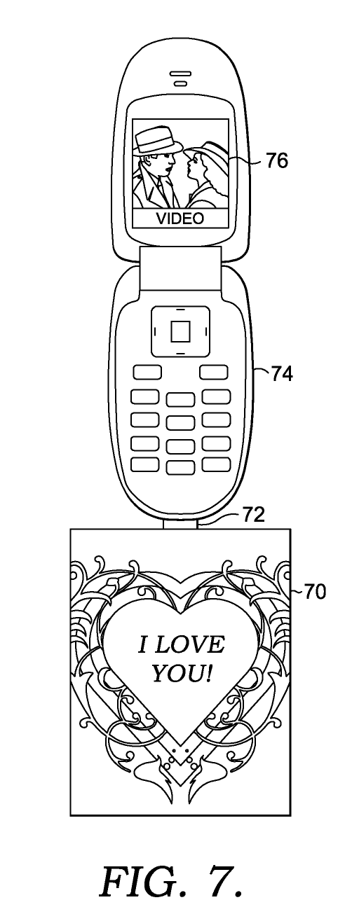

In embodiments where the memory device 62 has a media file stored thereon, the file may be automatically executed after the gift card 50 has been connected via connector 48 to a multimedia player or computing device. For an example, FIG. 7 illustrates such an embodiment of the present invention. More particularly, in this embodiment, a card 70 has a connector 72. One skilled in the art will appreciate that card 70 may be any type of card, such as a greeting card, a gift card, etc. The connector 72, in this embodiment, is connected to a multimedia player, shown here as a cell phone 74. As discussed above, any multimedia player may be used with the card 70 and is within the scope of the invention, so long as the connector 72 of the card 70 is capable of connecting to the multimedia player and executing the file or software stored thereon.

In this embodiment, the memory device coupled with the card 70 has a video file stored thereon. Once the card 70 is connected to the cell phone 74 via connector 72, the video file is automatically executed and shown to the user on the screen 76 of the cell phone. This arrangement permits the card to transfer multimedia information without having to provide the card with its own screen to display the multimedia information. In other words, it permits the purchaser of the gift card to make use of a screen or display already on a device, owned by the recipient to display the multimedia information.

Turning now to FIG. 2, a greeting card 200 together with a removable card 28 is provided, as another embodiment of the present invention. The greeting card 200 includes a card body comprising panels 22, 24, and 26. As discussed above with respect to greeting card 100, panels 22, 24, and 26 may consist of a single piece of card stock that has been folded, or they may be individual panels that are joined to one another.

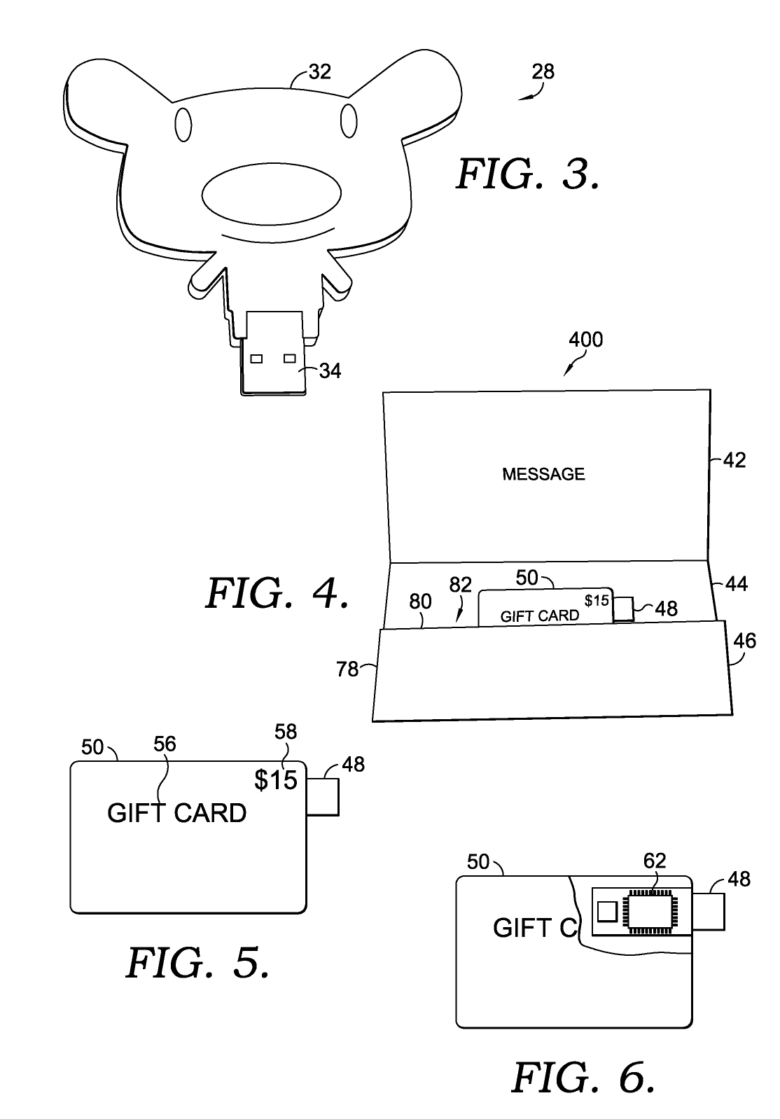

As shown in FIG. 2, the greeting card 200 includes a card 28 that is coupled therewith, but is also removable from the greeting card 200 for easy coupling with an electronic device such as a computer or multimedia player. In the illustrated embodiment, the card 28 is coupled to the greeting card 200 by a slot 30 in the greeting card 200, where the card 28 is secure enough to remain in the greeting card 200, but it may be removed, as is shown in FIG. 3. More specifically, the card 28 comprises a card body 32, a memory device (not shown), and a connector 34. As described above, the connector 34 may be any universal connector capable of connecting to a multimedia player, computing device, and the like.

In this embodiment, the card 28 illustrates a design of a character. Additionally, in the illustrated embodiment, the card body 32 is constructed in a shape to provide another design element to the card 38. Here, the card body 32 represents the shape and design of the character. Further, the design and/or shape of the card body may relate to the general design of the greeting card 200 in FIG. 5.

From the foregoing it will be seen that this invention is one well adapted to attain all ends and objects hereinabove set forth together with the other advantages which are obvious and which are inherent to the method and apparatus. It will be understood that certain features and subcombinations are of utility and may be employed without reference to other features and subcombinations. This is contemplated by and is within the scope of the invention.

Since many possible embodiments may be made of the invention without departing from the scope thereof, it is to be understood that all matter herein set forth or shown in the accompanying drawings is to be interpreted as illustrative of applications of the principles of this invention, and not in a limiting sense.

What is claimed is:

1. A card comprising:
a card body;
a memory device coupled with the card body, wherein the memory device stores a file; and
a connector coupled with the card body and with the memory device, the connector having the capability to connect the card to a multimedia player, wherein the memory device interacts with the multimedia player to execute the file.

2. The card of claim 1, wherein the connector is a universal serial bus (USB) plug.

3. The card of claim 1, wherein the multimedia player is selected from the group consisting of a cell phone, a PDA, a handheld gaming device, a gaming device, a video player, an audio player, a GPS, a Blackberry and a computer.

4. The card of claim 1, wherein the card is coupled with a greeting card, the greeting card having a design associated therewith.

5. The card of claim 4, wherein the card has a design associated therewith that corresponds to the design of the greeting card.

6. The card of claim 1, wherein the file is selected from the group consisting of a video file, an audio file, an image file and a multimedia file.

7. The card of claim 1, wherein the file is an executable file.

8. The card of claim 7, wherein the executable file opens a browser when the multimedia player to which the card is connected is a computer and wherein the executable file directs the browser to a website address associated with the card.

9. The card of claim 1, wherein the card is a greeting card.

10. The card of claim 1, wherein the card is a gift card.

11. A greeting card comprising:
a card body;
a memory device coupled with the card body, wherein the memory device comprises executable software; and
a connector coupled with the card body and with the memory device, the connector having the capability to connect the greeting card to a computing device, wherein the executable software causes the computing device to present a customized interface.

12. The greeting card of claim 11, wherein the connector is a universal serial bus (USB) plug.

13. The greeting card of claim 11, wherein the interface has been customized by a person from whom the greeting card has been given.

14. The greeting card of claim 11, wherein the customized interface includes images.

15. The greeting card of claim 11, wherein the customized interface includes video.

16. The greeting card of claim 11, wherein the executable software further causes the computing device to present a webpage.

17. A gift card comprising:
a gift card body;
a memory device coupled with the gift card body; and
a connector coupled with the gift card body and the memory device, wherein the connector is capable of connecting to a computing device, and once connected, the computing device directs the recipient of the gift card to a webpage associated with the gift card.

18. The gift card of claim 17, wherein the gift card further includes a monetary value.

19. The gift card of claim 18, wherein the recipient may purchase an item from the webpage using the monetary value on the gift card.

20. The gift card of claim 17, wherein the gift card is coupled with a greeting card.
